(19) United States
(12) Patent Application Publication
(10) Pub. No.: US 2020/0410529 A1
(43) Pub. Date: Dec. 31, 2020

(54) UNBIASED ESTIMATE OF CAUSAL EFFECTS IN ONLINE EXPERIMENTS

(71) Applicant: Microsoft Technology Licensing, LLC, Redmond, WA (US)

(72) Inventors: Kirill Sergeyevich Lebedev, Novato, CA (US); Mahesh Gupta, Santa Clara, CA (US); Qiongjia Xu, Sunnyvale, CA (US); Weishi Zeng, San jose, CA (US); Shaochen Huang, San Francisco, CA (US); Alexander Ivaniuk, Sunnyvale, CA (US); Colin Heinzmann, Mountain View, CA (US); Justin Marsh, Sunnyvale, CA (US); Ruirui Xiang, Mountain View, CA (US); Elise Georis, San Francisco, CA (US); Min Liu, Palo Alto, CA (US); Mindaou Gu, Sunnyvale, CA (US)

(21) Appl. No.: 16/457,636

(22) Filed: Jun. 28, 2019

(51) Int. Cl. G06Q 30/02

(52) U.S. Cl. CPC G06Q 30/0243; G06Q 30/0257

(57) ABSTRACT

Techniques for generating unbiased estimates of causal effects in online experiments are provided. In one technique, campaign data is received that includes a first set of targeting criteria and a second set of targeting criteria. An online experiment is established that comprises a content delivery campaign that is associated with a treatment group and a control group. Afterward, a content request is received and a first entity that initiated the content request is identified. In response to determining that the first entity is targeted by the campaign based on the first set of targeting criteria, the first entity is randomly assigned to the control group. In responses to second content request, a second entity is identified. In response to determining that the second entity is targeted by the campaign based on the first set of targeting criteria, the second entity is randomly assigned to the treatment group.

### TECHNICAL FIELD

The present disclosure relates generally to online experiments involving electronic content delivery and, more specifically, to designing online experiments to make unbiased estimates of online performance.

### BACKGROUND

Many content providers rely on content distribution platforms to distribute their respective electronic content to many end-users operating computing devices. Such a user visits a publisher system, which triggers a content request to a content distribution platform for potentially relevant content provided by a content provider. In addition to content requested from the publisher system, the user is presented with one or more content items from the content distribution platform.

However, content providers have numerous options in what content to present to end-users, in how the content is formatted, in who to target, and in objectives for their respective campaigns. For example, a content provider may use image A or image B for a content item, but not both. Image A may result in more engagement among end-users than image B or image A may result in a higher ROI than image B. In order to determine which image to use in a content delivery campaign, a content provider might start two different campaigns, one with image A and the other with image B, but both targeting the same audience. Then, the content provider would have to manually check the performance of each campaign, such as daily, to determine which campaign has performed the best in terms of one or more metrics (e.g., selections and/or another type of action). However, the content provider is not guaranteed that a user that views a content item with image A will also not view a content item with image B and vice versa. Thus, an experimental campaign may affect the performance of the other campaign. Also, the content provider may assume that any difference in campaign performance is statistically significant when in reality is the difference is not statistically significant. Thus, the content provider may end the online experiment before gathering sufficient data.

The approaches described in this section are approaches that could be pursued, but not necessarily approaches that have been previously conceived or pursued. Therefore, unless otherwise indicated, it should not be assumed that any of the approaches described in this section qualify as prior art merely by virtue of their inclusion in this section.

### BRIEF DESCRIPTION OF THE DRAWINGS

In the drawings:

FIG. 1 is a block diagram that depicts a system for distributing content items to one or more end-users, in an embodiment;

FIGS. 2A-2B are flow diagrams that depict an example process for conducting an unbiased online experiment involving different target audiences, in an embodiment;

FIGS. 3A-3C depict an example experiment population that includes multiple target audiences and a random split of the target audiences, in an embodiment;

FIG. 4 is a block diagram that illustrates a computer system upon which an embodiment of the invention may be implemented.

### DETAILED DESCRIPTION

In the following description, for the purposes of explanation, numerous specific details are set forth in order to provide a thorough understanding of the present invention. It will be apparent, however, that the present invention may be practiced without these specific details. In other instances, well-known structures and devices are shown in block diagram form in order to avoid unnecessarily obscuring the present invention.

### General Overview

Techniques for generating unbiased estimates of causal effects of online experiments are provided. In one technique, an unbiased targeting experiment is created and conducted. A content provider specifies targeting criteria of a content delivery campaign and multiple target audiences are identified. The target audiences are randomly split. Different entities from the same target audience are assigned to different groups (i.e., the control group and a treatment group).

In another technique, when a content delivery campaign corresponding to an online experiment is identified as a candidate campaign for a content item selection event, a record of that occurrence is created and stored, even though that campaign might never be selected as a result of the content item selection event. The record is used to count a number of times that campaign was a candidate and the count is used to determine whether one or more performance metrics of the online experiment are statistically significant. In this way, unbiased performance metrics may be calculated.

Embodiments improve computing technology by generating unbiased estimates of causal effects in online experiments. For example, with unbiased designs of an online experiment involving different target audiences, content providers are shielded from the details of how the target audiences are divided and can trust the results of the online experiment. The unbiased design allows content providers to determine which targeting criterion results in the highest lift, whereas results from a naïve design of the online experiment does not allow content providers to make that determination. As another example, with unbiased performance metrics generated in a scalable way, content providers are able to make informed decisions on which variants performed best and can conserve time and resources targeting the proper audience or targeting an audience in the proper way. Additionally, with unbiased performance metrics, an online experiment may be stopped automatically at an optimal time; neither too early nor too late. In this way, content providers are not required to manually compute the performance metrics and can trust that the system makes optimal stopping decisions.

### System Overview

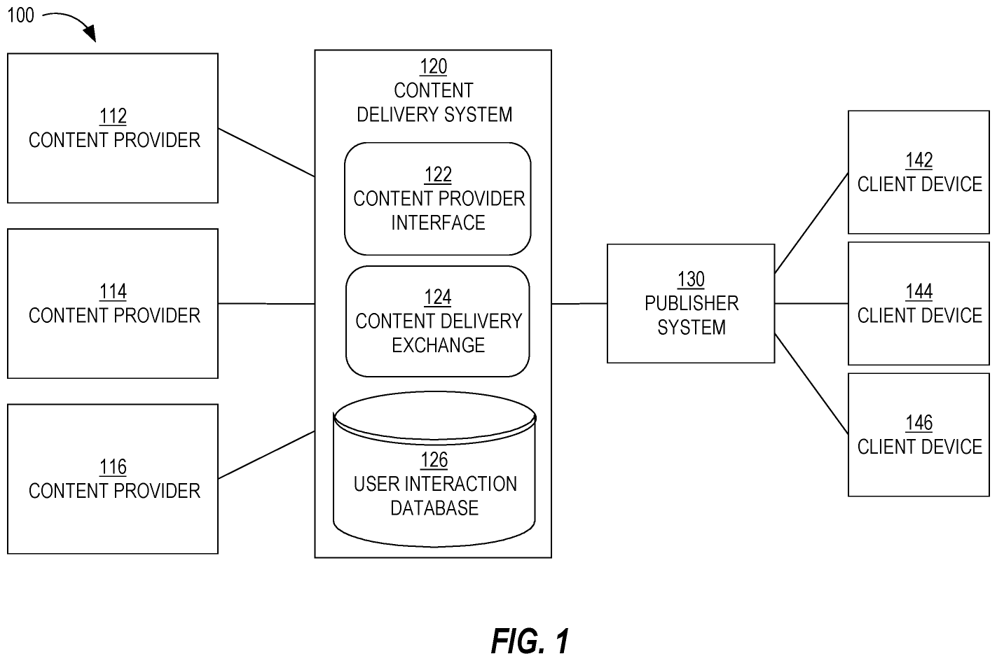

FIG. 1 is a block diagram that depicts a system 100 for distributing content items to one or more end-users, in an embodiment. System 100 includes content providers 112-116, a content delivery system 120, a publisher system 130, and client devices 142-146. Although three content providers are depicted, system 100 may include more or less content providers. Similarly, system 100 may include more than one publisher and more or less client devices.

Content providers 112-116 interact with content delivery system 120 (e.g., over a network, such as a LAN, WAN, or the Internet) to enable content items to be presented, through publisher system 130, to end-users operating client devices 142-146. Thus, content providers 112-116 provide content items to content delivery system 120, which in turn selects content items to provide to publisher system 130 for presentation to users of client devices 142-146. However, at the time that content provider 112 registers with content delivery system 120, neither party may know which end-users or client devices will receive content items from content provider 112.

An example of a content provider includes an advertiser. An advertiser of a product or service may be the same party as the party that makes or provides the product or service. Alternatively, an advertiser may contract with a producer or service provider to market or advertise a product or service provided by the producer/service provider. Another example of a content provider is an online ad network that contracts with multiple advertisers to provide content items (e.g., advertisements) to end users, either through publishers directly or indirectly through content delivery system 120.

Although depicted in a single element, content delivery system 120 may comprise multiple computing elements and devices, connected in a local network or distributed regionally or globally across many networks, such as the Internet. Thus, content delivery system 120 may comprise multiple computing elements, including file servers and database systems. For example, content delivery system 120 includes (1) a content provider interface 122 that allows content providers 112-116 to create and manage their respective content delivery campaigns and (2) a content delivery exchange 124 that conducts content item selection events in response to content requests from a third-party content delivery exchange and/or from publisher systems, such as publisher system 130.

Publisher system 130 provides its own content to client devices 142-146 in response to requests initiated by users of client devices 142-146. The content may be about any topic, such as news, sports, finance, and traveling. Publishers may vary greatly in size and influence, such as Fortune 500 companies, social network providers, and individual bloggers. A content request from a client device may be in the form of a HTTP request that includes a Uniform Resource Locator (URL) and may be issued from a web browser or a software application that is configured to only communicate with publisher system 130 (and/or its affiliates). A content request may be a request that is immediately preceded by user input (e.g., selecting a hyperlink on web page) or may be initiated as part of a subscription, such as through a Rich Site Summary (RSS) feed. In response to a request for content from a client device, publisher system 130 provides the requested content (e.g., a web page) to the client device.

Simultaneously or immediately before or after the requested content is sent to a client device, a content request is sent to content delivery system 120 (or, more specifically, to content delivery exchange 124). That request is sent (over a network, such as a LAN, WAN, or the Internet) by publisher system 130 or by the client device that requested the original content from publisher system 130. For example, a web page that the client device renders includes one or more calls (or HTTP requests) to content delivery exchange 124 for one or more content items. In response, content delivery exchange 124 provides (over a network, such as a LAN, WAN, or the Internet) one or more particular content items to the client device directly or through publisher system 130. In this way, the one or more particular content items may be presented (e.g., displayed) concurrently with the content requested by the client device from publisher system 130.

In response to receiving a content request, content delivery exchange 124 initiates a content item selection event that involves selecting one or more content items (from among multiple content items) to present to the client device that initiated the content request. An example of a content item selection event is an auction.

Content delivery system 120 and publisher system 130 may be owned and operated by the same entity or party. Alternatively, content delivery system 120 and publisher system 130 are owned and operated by different entities or parties.

A content item may comprise an image, a video, audio, text, graphics, virtual reality, or any combination thereof. A content item may also include a link (or URL) such that, when a user selects (e.g., with a finger on a touchscreen or with a cursor of a mouse device) the content item, a (e.g., HTTP) request is sent over a network (e.g., the Internet) to a destination indicated by the link. In response, content of a web page corresponding to the link may be displayed on the user's client device.

Examples of client devices 142-146 include desktop computers, laptop computers, tablet computers, wearable devices, video game consoles, and smartphones.

### Bidders

In a related embodiment, system 100 also includes one or more bidders (not depicted). A bidder is a party that is different than a content provider, that interacts with content delivery exchange 124, and that bids for space (on one or more publisher systems, such as publisher system 130) to present content items on behalf of multiple content providers. Thus, a bidder is another source of content items that content delivery exchange 124 may select for presentation through publisher system 130. Thus, a bidder acts as a content provider to content delivery exchange 124 or publisher system 130. Examples of bidders include AppNexus, DoubleClick, and LinkedIn. Because bidders act on behalf of content providers (e.g., advertisers), bidders create content delivery campaigns and, thus, specify user targeting criteria and, optionally, frequency cap rules, similar to a traditional content provider.

In a related embodiment, system 100 includes one or more bidders but no content providers. However, embodiments described herein are applicable to any of the above-described system arrangements.

### Content Delivery Campaigns

Each content provider establishes a content delivery campaign with content delivery system 120 through, for example, content provider interface 122. An example of content provider interface 122 is Campaign Manager™ provided by LinkedIn. Content provider interface 122 comprises a set of user interfaces that allow a representative of a content provider to create an account for the content provider, create one or more content delivery campaigns within the account, and establish one or more attributes of each content delivery campaign. Examples of campaign attributes are described in detail below.

A content delivery campaign includes (or is associated with) one or more content items. Thus, the same content item may be presented to users of client devices 142-146. Alternatively, a content delivery campaign may be designed such that the same user is (or different users are) presented different content items from the same campaign. For example, the content items of a content delivery campaign may have a specific order, such that one content item is not presented to a user before another content item is presented to that user.

A content delivery campaign is an organized way to present information to users that qualify for the campaign. Different content providers have different purposes in establishing a content delivery campaign. Example purposes include having users view a particular video or web page, fill out a form with personal information, purchase a product or service, make a donation to a charitable organization, volunteer time at an organization, or become aware of an enterprise or initiative, whether commercial, charitable, or political.

A content delivery campaign has a start date/time and, optionally, a defined end date/time. For example, a content delivery campaign may be to present a set of content items from Jun. 1, 2015 to Aug. 1, 2015, regardless of the number of times the set of content items are presented (“impressions”), the number of user selections of the content items (e.g., click throughs), or the number of conversions that resulted from the content delivery campaign. Thus, in this example, there is a definite (or “hard”) end date. As another example, a content delivery campaign may have a “soft” end date, where the content delivery campaign ends when the corresponding set of content items are displayed a certain number of times, when a certain number of users view, select, or click on the set of content items, when a certain number of users purchase a product/service associated with the content delivery campaign or fill out a particular form on a website, or when a budget of the content delivery campaign has been exhausted.

A content delivery campaign may specify one or more targeting criteria that are used to determine whether to present a content item of the content delivery campaign to one or more users. (In most content delivery systems, targeting criteria cannot be so granular as to target individual members.) Example factors include date of presentation, time of day of presentation, characteristics of a user to which the content item will be presented, attributes of a computing device that will present the content item, identity of the publisher, etc. Examples of characteristics of a user include demographic information, geographic information (e.g., of an employer), job title, employment status, academic degrees earned, academic institutions attended, former employers, current employer, number of connections in a social network, number and type of skills, number of endorsements, and stated interests. Examples of attributes of a computing device include type of device (e.g., smartphone, tablet, desktop, laptop), geographical location, operating system type and version, size of screen, etc.

For example, targeting criteria of a particular content delivery campaign may indicate that a content item is to be presented to users with at least one undergraduate degree, who are unemployed, who are accessing from South America, and where the request for content items is initiated by a smartphone of the user. If content delivery exchange 124 receives, from a computing device, a request that does not satisfy the targeting criteria, then content delivery exchange 124 ensures that any content items associated with the particular content delivery campaign are not sent to the computing device.

Thus, content delivery exchange 124 is responsible for selecting a content delivery campaign in response to a request from a remote computing device by comparing (1) targeting data associated with the computing device and/or a user of the computing device with (2) targeting criteria of one or more content delivery campaigns. Multiple content delivery campaigns may be identified in response to the request as being relevant to the user of the computing device. Content delivery exchange 124 may select a strict subset of the identified content delivery campaigns from which content items will be identified and presented to the user of the computing device.

Instead of one set of targeting criteria, a single content delivery campaign may be associated with multiple sets of targeting criteria. For example, one set of targeting criteria may be used during one period of time of the content delivery campaign and another set of targeting criteria may be used during another period of time of the campaign. As another example, a content delivery campaign may be associated with multiple content items, one of which may be associated with one set of targeting criteria and another one of which is associated with a different set of targeting criteria. Thus, while one content request from publisher system 130 may not satisfy targeting criteria of one content item of a campaign, the same content request may satisfy targeting criteria of another content item of the campaign.

Different content delivery campaigns that content delivery system 120 manages may have different charge models. For example, content delivery system 120 (or, rather, the entity that operates content delivery system 120) may charge a content provider of one content delivery campaign for each presentation of a content item from the content delivery campaign (referred to herein as cost per impression or CPM). Content delivery system 120 may charge a content provider of another content delivery campaign for each time a user interacts with a content item from the content delivery campaign, such as selecting or clicking on the content item (referred to herein as cost per click or CPC). Content delivery system 120 may charge a content provider of another content delivery campaign for each time a user performs a particular action, such as purchasing a product or service, downloading a software application, or filling out a form (referred to herein as cost per action or CPA). Content delivery system 120 may manage only campaigns that are of the same type of charging model or may manage campaigns that are of any combination of the three types of charging models.

A content delivery campaign may be associated with a resource budget that indicates how much the corresponding content provider is willing to be charged by content delivery system 120, such as $100 or $5,200. A content delivery campaign may also be associated with a bid amount that indicates how much the corresponding content provider is willing to be charged for each impression, click, or other action. For example, a CPM campaign may bid five cents for an impression, a CPC campaign may bid five dollars for a click, and a CPA campaign may bid five hundred dollars for a conversion (e.g., a purchase of a product or service).

### Content Item Selection Events

As mentioned previously, a content item selection event is when multiple content items (e.g., from different content delivery campaigns) are considered and a subset selected for presentation on a computing device in response to a request. Thus, each content request that content delivery exchange 124 receives triggers a content item selection event.

For example, in response to receiving a content request, content delivery exchange 124 analyzes multiple content delivery campaigns to determine whether attributes associated with the content request (e.g., attributes of a user that initiated the content request, attributes of a computing device operated by the user, current date/time) satisfy targeting criteria associated with each of the analyzed content delivery campaigns. If so, the content delivery campaign is considered a candidate content delivery campaign. One or more filtering criteria may be applied to a set of candidate content delivery campaigns to reduce the total number of candidates.

As another example, users are assigned to content delivery campaigns (or specific content items within campaigns) “off-line”; that is, before content delivery exchange 124 receives a content request that is initiated by the user. For example, when a content delivery campaign is created based on input from a content provider, one or more computing components may compare the targeting criteria of the content delivery campaign with attributes of many users to determine which users are to be targeted by the content delivery campaign. If a user's attributes satisfy the targeting criteria of the content delivery campaign, then the user is assigned to a target audience of the content delivery campaign. Thus, an association between the user and the content delivery campaign is made. Later, when a content request that is initiated by the user is received, all the content delivery campaigns that are associated with the user may be quickly identified, in order to avoid real-time (or on-the-fly) processing of the targeting criteria. Some of the identified campaigns may be further filtered based on, for example, the campaign being deactivated or terminated, the device that the user is operating being of a different type (e.g., desktop) than the type of device targeted by the campaign (e.g., mobile device).

A final set of candidate content delivery campaigns is ranked based on one or more criteria, such as predicted click-through rate (which may be relevant only for CPC campaigns), effective cost per impression (which may be relevant to CPC, CPM, and CPA campaigns), and/or bid price. Each content delivery campaign may be associated with a bid price that represents how much the corresponding content provider is willing to pay (e.g., content delivery system 120) for having a content item of the campaign presented to an end-user or selected by an end-user. Different content delivery campaigns may have different bid prices. Generally, content delivery campaigns associated with relatively higher bid prices will be selected for displaying their respective content items relative to content items of content delivery campaigns associated with relatively lower bid prices. Other factors may limit the effect of bid prices, such as objective measures of quality of the content items (e.g., actual click-through rate (CTR) and/or predicted CTR of each content item), budget pacing (which controls how fast a campaign's budget is used and, thus, may limit a content item from being displayed at certain times), frequency capping (which limits how often a content item is presented to the same person), and a domain of a URL that a content item might include.

An example of a content item selection event is an advertisement auction, or simply an “ad auction.”

In one embodiment, content delivery exchange 124 conducts one or more content item selection events. Thus, content delivery exchange 124 has access to all data associated with making a decision of which content item(s) to select, including bid price of each campaign in the final set of content delivery campaigns, an identity of an end-user to which the selected content item(s) will be presented, an indication of whether a content item from each campaign was presented to the end-user, a predicted CTR of each campaign, a CPC or CPM of each campaign.

In another embodiment, an exchange that is owned and operated by an entity that is different than the entity that operates content delivery system 120 conducts one or more content item selection events. In this latter embodiment, content delivery system 120 sends one or more content items to the other exchange, which selects one or more content items from among multiple content items that the other exchange receives from multiple sources. In this embodiment, content delivery exchange 124 does not necessarily know (a) which content item was selected if the selected content item was from a different source than content delivery system 120 or (b) the bid prices of each content item that was part of the content item selection event. Thus, the other exchange may provide, to content delivery system 120, information regarding one or more bid prices and, optionally, other information associated with the content item(s) that was/were selected during a content item selection event, information such as the minimum winning bid or the highest bid of the content item that was not selected during the content item selection event.

### Event Logging

Content delivery system 120 may log one or more types of events, with respect to content item, across client devices 142-146 (and other client devices not depicted). For example, content delivery system 120 determines whether a content item that content delivery exchange 124 delivers is presented at (e.g., displayed by or played back at) a client device. Such an “event” is referred to as an “impression.” As another example, content delivery system 120 determines whether a user interacted with a content item that exchange 124 delivered to a client device of the user. Examples of “user interaction” include a view or a selection, such as a “click.” Content delivery system 120 stores such data as user interaction data, such as an impression data set and/or a interaction data set. Thus, content delivery system 120 may include a user interaction database 128. Logging such events allows content delivery system 120 to track how well different content items and/or campaigns perform.

For example, content delivery system 120 receives impression data items, each of which is associated with a different instance of an impression and a particular content item. An impression data item may indicate a particular content item, a date of the impression, a time of the impression, a particular publisher or source (e.g., onsite v. offsite), a particular client device that displayed the specific content item (e.g., through a client device identifier), and/or a user identifier of a user that operates the particular client device. Thus, if content delivery system 120 manages delivery of multiple content items, then different impression data items may be associated with different content items. One or more of these individual data items may be encrypted to protect privacy of the end-user.

Similarly, an interaction data item may indicate a particular content item, a date of the user interaction, a time of the user interaction, a particular publisher or source (e.g., onsite v. offsite), a particular client device that displayed the specific content item, and/or a user identifier of a user that operates the particular client device. If impression data items are generated and processed properly, an interaction data item should be associated with an impression data item that corresponds to the interaction data item. From interaction data items and impression data items associated with a content item, content delivery system 120 may calculate an observed (or actual) user interaction rate (e.g., CTR) for the content item. Also, from interaction data items and impression data items associated with a content delivery campaign (or multiple content items from the same content delivery campaign), content delivery system 120 may calculate a user interaction rate for the content delivery campaign. Additionally, from interaction data items and impression data items associated with a content provider (or content items from different content delivery campaigns initiated by the content item), content delivery system 120 may calculate a user interaction rate for the content provider. Similarly, from interaction data items and impression data items associated with a class or segment of users (or users that satisfy certain criteria, such as users that have a particular job title), content delivery system 120 may calculate a user interaction rate for the class or segment. In fact, a user interaction rate may be calculated along a combination of one or more different user and/or content item attributes or dimensions, such as geography, job title, skills, content provider, certain keywords in content items, etc.

### Online Experiments

In an embodiment, a content provider establishes one or more online experiments that are conducted by content delivery system 120. The content provider may leverage content provider interface 122 to specify attributes of an online experiment. An online experiment is a comparison of two or more cells. A “cell” is a treatment unit that contains one campaign. Metadata for a cell may include a cell name and a traffic weight that dictates how much online traffic will be processed in light of the cell relative to one or more other cells of the same online experiment. A traffic weight indicates a percentage of the total members in an experiment that receive a given cell treatment. The sum of all traffic weights in an online experiment may equal 100 (or 1), indicating the total members.

An online experiment is either on or off. An online experiment may have an auto-stop status. Such a status is used to determine whether to (a) automatically stop the online experiment once a winning cell has been declared and automatically stop all campaigns within the online experiment, (b) automatically stop the online experiment once the online experiment reaches an end date, and automatically stop all campaigns within the online experiment; or (c) automatically stop the online experiment once the online campaign reaches an end date, but allow the campaigns to keep running.

In an embodiment, an online experiment is checked regularly (e.g., daily or weekly) to determine whether the online experiment contains a cell that is the best according to one or more performance criteria.

A confidence threshold level may be defined such that if the system generates a confidence level, in a winning cell, that is greater than the confidence threshold level, then the system declares that cell as the winning cell. For example, at a confidence level of 90, there is a 90% chance that the system would choose the same winner if the online experiment was run multiple times. The confidence threshold may have a default value and/or may be defined by a user, such as a content provider of the corresponding online experiment.

In an embodiment, a duration forecast is generated that indicates a remaining amount of time needed to reach statistical significant for a given experiment.

Thus, each online experiment may include one or more the following parameters/characteristics: Name, Description, Start time, End time, Experiment type (e.g., Split test or lift test), Auto-Stop Status (e.g., online experiment automatically stops when a winner is determined or at an end date of the experiment, or auto stop is disabled), Confidence level, and Key metric, such as Cost per click, Cost per lead (restricted to lead content items), Cost per thousand impressions, Cost per video view (restricted to video content items), Cost per message sent (restricted to message content items), and Cost per [paid] conversion.

An online experiment winner is the variant that has the lowest key metric (in cases where the lower the key metric the better, such as cost per click) or the highest key metric (in cases where the higher the key metric the better, such as conversion rate).

In an embodiment, a content provider is allowed to edit all parameters of an online experiment. However, in a related embodiment, after the online experiment begins, the content provider can only edit the certain parameters, such as Name, Description, End time (i.e., ability to extend the online experiment, even after the online experiment has finished), Auto-stop status, Confidence level, and Cell metadata (such as names and descriptions). Other parameters of an online experiment may be immutable once the online experiment begins, such as Start time, Key metric, and Cell contents (such as campaign IDs and traffic weights).

In an embodiment, there is no overlap between the audiences that receive different cell treatments within a single online experiment. Thus, an individual user is not exposed to more than one cell treatment within a single online experiment. Once a user is assigned to one treatment of an online experiment, that user is not reassigned to another cell treatment of the same online experiment.

### Experiment Report

In an embodiment, a content provider is allowed to request an experiment report at any time, regardless of whether the online experiment is currently running/active.

An experiment report may include one or more of the following data: Experiment parameters (e.g., Name, Description, Start time, Scheduled end time, Actual end time, Creation time, Last update time, Experiment type (e.g., split test or lift test), Key metric, Auto-stop status), Experiment status (running, on hold, stopped, ended), Reason for end of experiment, if applicable (e.g., Experiment reached scheduled end date, Auto-stop=AUTO_STOP_AT_WINNER, and a winner was declared, Error (e.g., a campaign involved in the experiment was terminated, the experimentation service failed, etc.)), Values for each of the following metrics (Key metric (e.g., cost per click), Raw value of the key metric (e.g., number of clicks), % budget utilized (lock in budget after experiment ends), Spend to date, CTR, Impressions, Clicks), Array of cell data (e.g., Cell name, Campaign ID, Traffic weight), P-value (after reaching confidence level), Winning cell (if applicable), and Confidence level (if applicable).

### A/B Testing

A/B testing is a randomized experiment with two variants, A and B. A/B testing includes application of statistical hypothesis testing or “two-sample hypothesis testing” as used in the field of statistics. A/B testing is a way to compare two versions of a single variable, typically by testing a subject's response to variant A against variant B and determining which of the two variants is more effective. As the name implies, two versions (A and B) are compared, which are identical except for one variation that might affect a user's behavior. Version A might be the currently used version (control), while version B is modified in some respect (treatment). For instance, on an e-commerce website the purchase funnel is typically a good candidate for A/B testing, as even marginal improvements in drop-off rates can represent a significant gain in sales. Significant improvements can sometimes be seen through testing elements like copy text, layouts, images and colors, but not always. Thus, a primary reason for doing A/B testing is to obtain an unbiased estimate of causal effects. An unbiased design is preferred over a biased design.

An A/B test on targeting criteria answers a question of the following type: if either target audience A (e.g., students) or target audience B (e.g., job seekers) could be targeted, which targeting audience results in the biggest lift on metrics (e.g., subscribe to email)? Note, this is not the same question as comparing target audience A to target audience B. However, one intuitive approach for designing an A/B test involving different target audiences is to place all members of one target audience into a control group and all members of another target audience into a treatment group and determine which group has better performance metrics (e.g., highest CTR, lowest CPC) given the same or similar budget. However, in the context of job-related content items and the example of job seekers versus students, job seekers will almost always react more positively to a content delivery campaign targeting them than students. Also, content providers are more interested in lift than the relative difference between performance of the two groups.

As an analogy, a campaign manager for a presidential candidate does not want to spend campaign money on either deep blue states or deep red states, but rather, on the swing states, where it is possible to get the biggest lift. If the campaign manager created an online experiment and compared a key performance metric of target audience A (e.g., a blue state) to a key performance metric of target audience B (e.g., a red state), then the campaign manager would end up launching online campaigns in the states where his/her candidate is most loved, which may be a waste of effort.

### Conducting an AB Test Involving Target Audiences

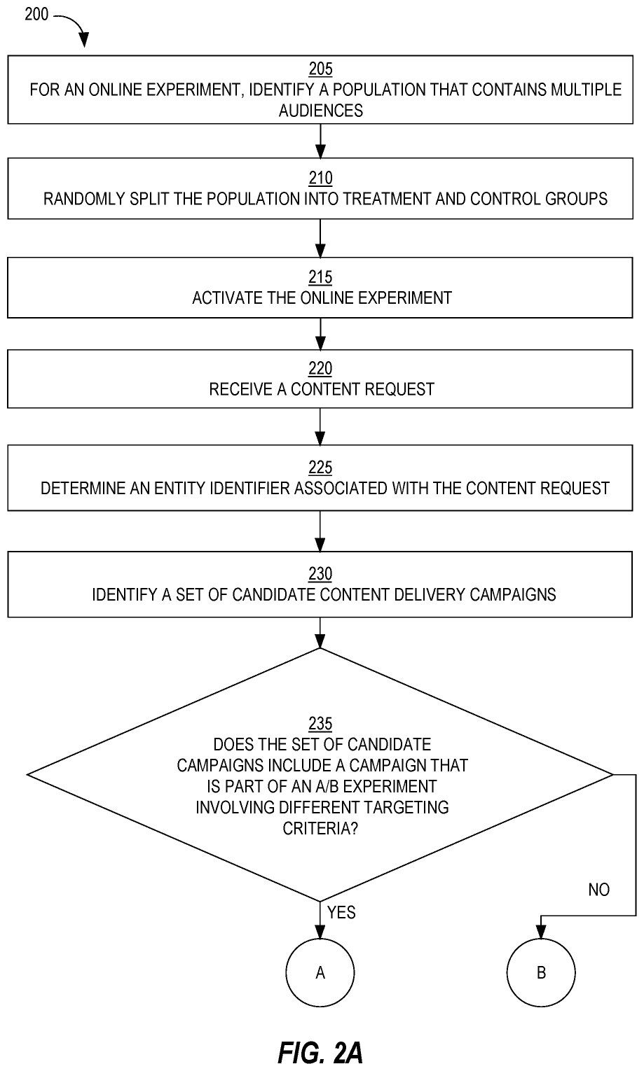

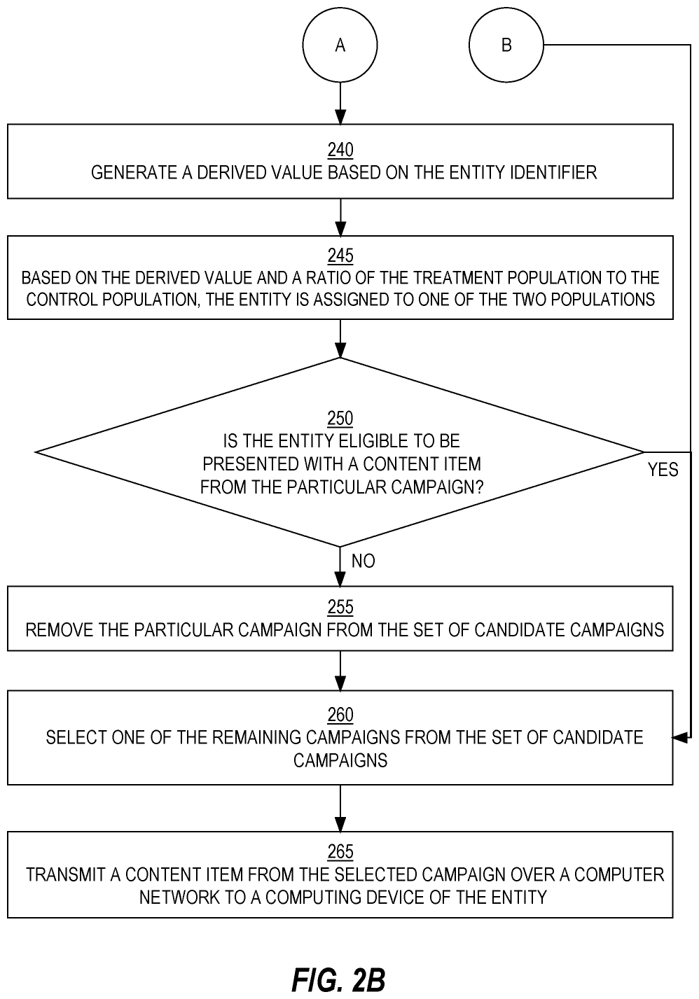

FIGS. 2A-2B are flow diagrams that depict an example process 200 for conducting an unbiased online experiment involving different target audiences, in an embodiment.

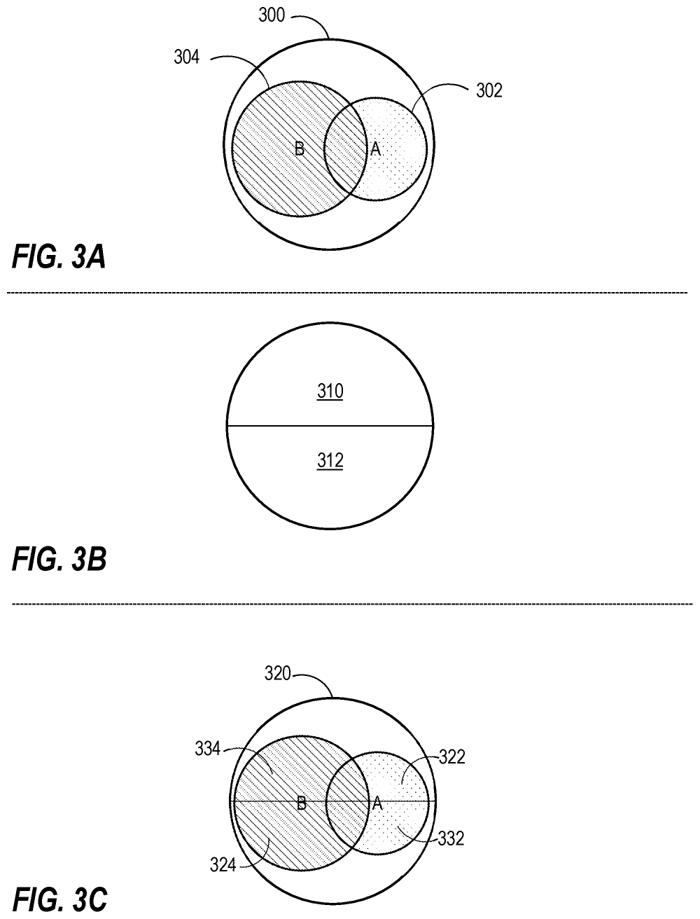

At block 205, a population that contains both audience A and audience B as the experiment population is identified. In FIG. 3A, the experiment population 300 includes audience A 302 and audience B 304. The experiment population may be specified in targeting criteria that a content provider inputs through content provider interface 122. For example, targeting criteria may include the following predicates comprising attribute-attribute value pairs and Boolean logic that combines the predicates: “{academic degree: computer science, computer engineering} && ({employment status: job seeker}∥{student status: student}).”

In the example of FIG. 3A, the two different audiences overlap. In other embodiments, the two different audiences do not overlap. Also, FIG. 3A indicates that there are some users that are outside both audiences 302 and 304. However, in other online experiments, no users targeted by an online experiment are in neither audience.

At block 210, the experiment population is randomly split into treatment and control groups along one of the targeting criteria. The split may be 50/50, 30/70, or any other split ratio. In FIG. 3B, the treatment population 310 is separate from the control population 312. The content provider has no control in how the experiment population is split, other than possibly specifying a value that indicates relative sizes of each sub-population (i.e., treatment population and control population). Such an approach is a prerequisite of an unbiased design because the treatment and control populations are randomly assigned.

FIG. 3C depicts an experiment population 320 split into two treatment and control groups, each group including different portions of audiences A and B. The users in half circle 322 and half circle 324 are users that are eligible to be presented with content items from the experiment. Thus, in treatment, only portion 322 (i.e., of audience A) is targeted and, in control, only portion 324 (i.e., of audience B) is targeted. Also, users in portion 332 (of audience A) are not targeted and neither are users in portion 334 (of audience B). For example, in the example where target audience A are job seekers and target audience B are students, a job seeker is randomly assigned to one of the two groups or sub-populations. If the job seeker is randomly assigned to the treatment population, then the job seeker is eligible to be presented with a content item associated with the experiment. Conversely, if the job seeker is randomly assigned to the control population, then the job seeker is not eligible to be presented with a content item associated with the experiment. Similarly, a student is randomly assigned to one of the two groups. If the student is randomly assigned to the control population, then the student is eligible to be presented with a content item associated with the online experiment; otherwise, the student is not so eligible. Eligible users in the control group are presented with one set of one or more content items and eligible users in the treatment group are presented with a different set of one or more content items.

Thus, a random portion of audience A is assigned to the control population and a random portion of audience B is assigned to the treatment population. The random portion of audience B that is not assigned to the control population will not be presented with a content item from the online experiment. Similarly, the random portion of audience A that is not assigned to the treatment population will not be presented with a content item from the online experiment. This is fair AB testing, where there is no difference between treatment and control group prior to test. It is important to note that the treatment population is not all audience B (e.g., students) and the control population is not all audience A (e.g., job seekers). Comparing a key performance metric of the treatment population to a key performance metric of the control population is a fair comparison, while comparing the key performance metrics of jobseekers to the key performance metrics of students is not.

If a content provider plans to launch the winner to 100% with budget b, then the treatment and control populations are each allocated r %*b and (100−r) %*b of the budget, respectively, where r is a value between 0 and 100.

Because it is not known ahead of time who will trigger a content item selection event, the random assignment of a user to one of the two populations might not occur until a content request is received that was initiated by the user. Thus, block 210 may involve determining a value r, such that if a derived value generated for a user is less than r, then the user is assigned to the control population, but if the derived value is greater than r, then the user is assigned to the treatment population. The value r may be a default value (e.g., 50) or may be specified by the content provider that initiated the online experiment. As described in more detail below, a user's derived value may be generated using one or more operations where the input is a user/member identifier that is associated with each user that initiates a content request that is received and processed by content delivery system 120, which triggers a content item selection event.

At block 215, the online experiment is made active such that any content items associated with the online experiment are eligible for presentation to certain segments of a target audience of the online experiment.

At block 220, a content request is received. For example, content delivery exchange 120 receives the content request over network 120 from client device 142 that renders content received from publisher system 130. A content item selection event is initiated.

At block 225, an entity identifier associated with the content request is determined. For example, the entity (or user) identifier is contained in the content request. As another example, the content request includes an identifier (e.g., a device identifier, a cookie identifier, a MAID or mobile advertising identifier) that is mapped to an entity identifier. The mapping is stored (or at least accessible to) content delivery exchange 120.

At block 230, a set of candidate content delivery campaigns are identified. Block 230 may be performed using the entity identifier. Some campaigns in the set might be part of an online experiment while other campaigns might not be part of an online experiment. Prior to block 230, the user may have been assigned to multiple campaigns. For example, at campaign creation or whenever a campaign's targeting criteria is updated, profiles of multiple users are analyzed to determine whether the profiles satisfy the targeting criteria of the campaign. If so, then the corresponding user is assigned to that campaign. In this way, campaign assignment is determined offline, before any content request associated with the user is received, thus allowing this candidate campaign identification step to be relatively fast.

At block 235, it is determined whether the set of candidate content delivery campaigns includes a particular campaign that is part of a AB experiment involving different targeting criteria. If so, process 200 proceeds to block 240; otherwise, process 200 proceeds to block 260.

At block 240, a derived value is generated based on the entity identifier. For example, entity user identifier is input to a hash function that is used to generate the derived value. As another example, a hash of an entity identifier is input to a modulo 100 (or mod 100) operation to compute a derived value between 0 and 100. Identifiers other than the entity identifier may be used to generate the derived value, such as a cookie identifier, an IP address, a MAC address, or a MAID.

At block 245, based on the derived value and the ratio of the treatment population to the control population, the user is assigned to one of the two populations. For example, if the ratio is 40/60, then a derived value that is between 0 and 40 is assigned to the treatment population and a derived value that is between 40 and 100 is assigned to the control population.

At block 250, it is determined whether the user is eligible to be presented with a content item from the particular campaign. Block 250 may involve looking up an audience-population mapping that maps one audience to a treatment population and another audience to a control population. For example, if the user is assigned to the treatment population and the audience-population mapping maps the user's audience to the control population, then the user is not eligible to be presented with a content item from the particular campaign. Conversely, if the user is assigned to the treatment population and the audience-population mapping maps the user's audience to the treatment population, then the user is eligible to be presented with a content item from the particular campaign.

If the set of candidate content delivery campaigns includes multiple campaigns that are each part of an AB experiment involving different targeting criteria, then block 250 may be performed multiple times, once for each such campaign.

If the determination of block 250 is negative, then process 200 proceeds to block 255; otherwise, process 200 proceeds to block 260.

At block 255, the particular campaign is removed from the set of candidate content delivery campaigns. Thus, the particular campaign is no longer considered for the current content item selection event.

At block 260, one the remaining candidate content delivery campaigns is selected. Block 260 may involve selecting the candidate campaign that is associated with the highest score. A campaign score may be calculating in one of multiple ways and may be based on one or more inputs, such as predicted user selection rate (e.g., pCTR), a predicted conversion rate, bid amount, or a combination of two or more of these inputs (e.g., a product of the pCTR and bid amount).

At block 265, a content item from the selected content delivery campaign is transmitted over a computer network (e.g., the Internet) to a computing device of the user. For example, the selected content delivery campaign may only be associated with a single content item, in which case the selection of the content item is trivial. Alternatively, the selected campaign may be associated with multiple content items, in which case one of the content items is selected for transmission. Such selection may be random, may be performed in a round robin fashion, or may be performed using one or more selection criteria, such as relative performance (e.g., actual/observed user selection rate) of the different content items.

Blocks 230-265 may be performed by content delivery exchange 124.

### Selecting a Winning Variant of an Online Experiment

An online experiment is useful to the extent that it can be confidently determined whether there is a winning variant. It is useful to know that one variant has performed better than another variant (e.g., in terms of user selection rate or cost per conversion). It is equally useful to know that neither variant performed better. Whichever determination is made, it is important to make the determination as early as possible to avoid wasting resources (both time and money) keeping the online experiment active.

In an embodiment, once a winning determination is made, the online experiment automatically ends. An “end” of an online experiment may mean that the campaigns of the online experiment become inactive (and therefore no longer participate in content item selection events) or that just the “losing” campaign(s) become inactive. Thus, a winning campaign may remain active. Additionally, any budget remaining from the losing campaign(s) may be added to any remaining budget of the winning campaign.

### Computing Statistical Significance to Determine a Winning Variant

A component of analyzing an online experiment is to compute statistical significance (e.g., p-value or confidence interval), which indicates whether the difference between metrics pertaining to different variants is real or primarily due to noise. The following is an example process for calculating p-values and confidence intervals for an AB test, especially when the results are aggregated across multiple days. The following metrics are known or computed:
a. total clicks for each variant (control and treatment), which are denoted, respectively, Y1c and Y1t
b. total impressions for each variant (control and treatment), which are denoted, respectively, X1c and X1t
c. Uniques count for impressions of each variant, which are denoted, respectively, Nc and Nt)
   i. “Uniques” count of a variant refers to a number of unique users in the variant who received an impression
d. For each user, if the sum of their impression is x, then x² is summed over all uniques in that variant, which are denoted, respectively, X2c and X2t
e. For each user, if the sum of the user's clicks is y, then y² summed over all uniques in that variant, which are denoted, respectively, Y2c and Y2t
   i. this is different from the summing and then squaring the values
f. Sum x*y over all uniques in that variant, which are denoted, respectively, Zc and Zt.

The above values are used to make the calculations listed in the following table:

TABLE A

| Terms | Calculation | Shorthand |
|---|---|---|
| CTR of control | Y1c/X1c | CTR |
| Mean Impressions | X1c/Nc | x_mc |
| Mean Clicks | Y1c/Nc | y_mc |
| Variance of Mean Impressions | ((X2c/Nc) − x_mc\hat{ }2)/Nc | x_varc |
| Variance of Mean Clicks | ((Y2c/Nc) − y_mc\hat{ }2)/Nc | y_varc |
| Covariance of Mean Impressions | ((Zc/Nc) − x_mc*y_mc)/Nc | z_cross_c |
| and Mean Clicks | | |
| Variance of | {y_varc/(x_mc\hat{ }2)} + {x_varc * | CTR_Var_c |
| (CTR of control) | (y_mc\hat{ }2)/(x_mc\hat{ }4)} − 2* | |
| | {(y_mc/x_mc\hat{ }3) * z_cross_c} | |
| Variance of (CTR of control - | CTR_Var_c + CTR_Var_t | |
| CTR of treatment) | | |

The following includes example input for the above base values and includes example code written in the R language for computing p-value based on those base values:

#### Manual input for base values
Nc = 3274373
Nt = 14728847
X1c = 40757119
X1t = 183258352
Y1c = 492855
Y1t = 2178062
X2c = 1475248589
X2t = 6641059340
Y2c = 1781457
Y2t = 8201826
Zc = 12151929
Zt = 53275227
#### Using a PigScript
data= read.csv(“email_ctr.1163522.b2_anet_digest.csv”,header=FALSE);
names(data)=c(“seg”,“variant”,“mobile”,“n”,“x1”,“y1”,“x2”,“y2”,“z”);
treatmentRow = 1
controlRow = 2
Nt = data$n[treatmentRow]
Nc = data$n[controlRow]
X1t = data$x1[treatmentRow]
X1c = data$x1[controlRow]
Y1t = data$y1[treatmentRow]
Y1c = data$y1[controlRow]
X2c = data$x2[controlRow]
X2t = data$x2[treatmentRow]
Y2c = data$y2[controlRow]
Y2t = data$y2[treatmentRow]
Zc = data$z[controlRow]
Zt = data$z[treatmentRow]
#### Computation
CTRt = Y1t / X1t;
CTRc = Y1c / X1c;
x_mc = X1c / Nc;
x_mt = X1t / Nt;
y_mc = Y1c / Nc;
y_mt = Y1t / Nt;
x_varc = ((X2c / Nc) − x_mc\hat{ }2)/ Nc;
y_varc = ((Y2c / Nc) − y_mc\hat{ }2)/ Nc;
x_vart = ((X2t / Nt) − x_mt\hat{ }2)/ Nt;
y_vart = ((Y2t / Nt) − y_mt\hat{ }2)/ Nt;
z_cross_c = ((Zc/Nc) − x_mc*y_mc)/ Nc;
z_cross_t = ((Zt/Nt) − x_mt*y_mt)/ Nt;
CTR_var_c = y_varc / x_mc\hat{ }2 + x_varc * y_mc\hat{ }2 / x_mc\hat{ }4 − 2*y_mc / x_mc\hat{ }3 *
z_cross_c;
CTR_var_t = y_vart / x_mt\hat{ }2 + x_vart * y_mt\hat{ }2 / x_mt\hat{ }4 − 2*y_mt / x_mt\hat{ }3 *
z_cross_t;
### delta, delta SE, and p-value
(CTRt − CTRc);
(CTR_sd_delta = sqrt(CTR_var_c + CTR_var_t));
(p_val = pnorm( − abs(CTRt−CTRc) / CTR_sd_delta)*2);
### %delta, %delta SE, and p-value
(CTRt − CTRc)/CTRc;
(percDeltaSD = sqrt(CTR_var_t / CTRc\hat{ }2 + CTR_var_c * CTRt\hat{ }2 / CTRc\hat{ }4));
(p_val = pnorm( − abs(CTRt−CTRc)/CTRc / percDeltaSD)*2);

The CTR_sd delta and p_val will yield, respectively, the standard deviation of the CTR difference and the p-value for the CTR difference as well. For confidence interval (CI), a standard TTest definition may be followed: CI=Mean+/−T*(SD/SQRT(n−1)) for each campaign, where T is a student distribution coefficient, SD is the standard deviation, and SQRT is the square root function.

### Unbiased Non-Targeting Experiment

The above techniques to compute a p-value and confidence intervals are used to determine whether the difference in performance metrics are statistically significant. If the difference in performance metrics is not statistically significantly, then the online experiment should continue. For example, if an online experiment involves testing two different images for a content item and determining which results in a higher user selection rate (e.g., CTR) and the difference in user selection rates is not statistically significant, then the online experiment continues and both images will continue to be served.

One important variable in determining whether a performance metric is statistically significant is the number of users in a group or sub-population or number of instances of a variant being tested (since some users may be tested multiple times while assigned to one of the groups). One approach for calculating the number of unique users (or number of instances) in the context of online content delivery campaigns is to increment the number at the conclusion of each content item selection event in which the content delivery campaign corresponding to the online experiment is selected. Thus, if a user is part of a treatment population of an online experiment and the campaign corresponding to that treatment population “won” the content item selection event and the user has not been seen before for that online experiment, then the number of instances of that treatment population (e.g., Nt referenced above) is incremented by one. However, only incrementing such values if a campaign wins a content item selection event results in relatively high variance measurements, which will make it difficult to reach statistically significant results.

In an embodiment, counting the number of users or the number of instances of an online experiment is based on whether a content delivery campaign of the online experiment is identified as a candidate in a content item selection event. This is done even though the campaign might be eventually filtered out or otherwise not selected at the end of the content item selection event. For example, the campaign may have a lower effective resource usage per impression (e.g., effective cost per impression) than other candidate content delivery campaigns. As another example, the campaign may be filtered due to pacing criteria that is used to smooth out the budget spend of a campaign over a period of time (e.g., day) so that the campaign's budget is not exhausted at the beginning (e.g., in the first few minutes) of that time period. As another example, the campaign may be filtered out as a result of a frequency cap rule that dictates how often a content item may be presented to a user over a period of time (e.g., no more than three impressions of a particular content item in a two day period).

In a content item selection event, multiple content delivery campaigns may correspond to different online experiments. For example, a content item selection event results in identifying ten candidate content delivery campaigns that are not part of an online experiment and five candidate content delivery campaigns that are part of an online experiment: campaign C1 is part of experiment X1, campaign C2 is part of experiment X2, and so forth. It is also determined that a user that triggered the content item selection event is associated with a treatment group of experiment X1, a control group of experiment X2, and so forth. Thus, a counter of the treatment group of experiment X1 is incremented, a counter of the control group of experiment X2 is incremented, and so forth.

In an embodiment, when a content delivery campaign corresponding to online experiment is identified, an event is generated. The event includes an experiment identifier that identifies the online experiment/campaign, a variant identifier that identifies a variant of the online experiment (e.g., treatment or control), and a timestamp that indicates a date and/or time the event was generated or when the campaign was identified as a result of the content item selection event. Content delivery exchange 124, which identifies a set of candidate content delivery campaigns, may generate the event and publish the event, which may involve storing the event in at a certain storage location. A downstream process (e.g., a subscriber) eventually reads the event and processes the event, such as aggregating events that include the same experiment identifier and the same variant identifier. In this way, an exact count of each variant may be calculated and used to compute unbiased performance metrics.

An example of an event stream processing system is Apache Kafka (or just “Kafka”), which is an open source stream processing software platform developed by LinkedIn. Kafka provides a unified, high-throughput, low-latency platform for handling real-time data feeds. A storage layer of Kafka is a scalable publish/subscribe message queue designed as a distributed transaction log, making it highly valuable for enterprise infrastructures to process streaming data. Additionally, Kafka connects to external systems (for data import/export) via Kafka Connect and provides Kafka Streams, a Java stream processing library.

### Hardware Overview

According to one embodiment, the techniques described herein are implemented by one or more special-purpose computing devices. The special-purpose computing devices may be hard-wired to perform the techniques, or may include digital electronic devices such as one or more application-specific integrated circuits (ASICs) or field programmable gate arrays (FPGAs) that are persistently programmed to perform the techniques, or may include one or more general purpose hardware processors programmed to perform the techniques pursuant to program instructions in firmware, memory, other storage, or a combination. Such special-purpose computing devices may also combine custom hard-wired logic, ASICs, or FPGAs with custom programming to accomplish the techniques. The special-purpose computing devices may be desktop computer systems, portable computer systems, handheld devices, networking devices or any other device that incorporates hard-wired and/or program logic to implement the techniques.

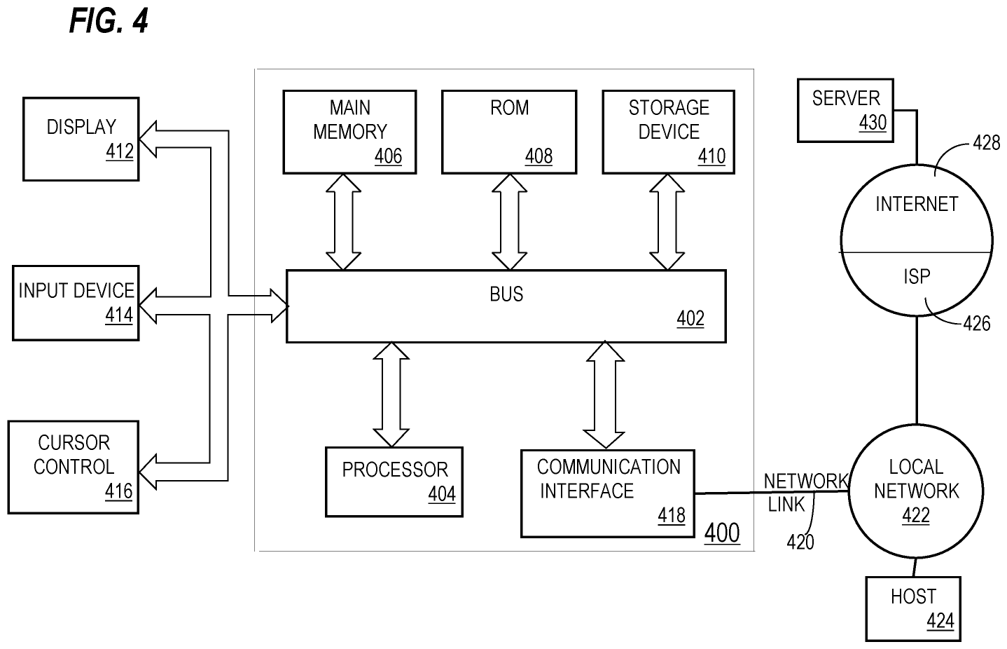

For example, FIG. 4 is a block diagram that illustrates a computer system 400 upon which an embodiment of the invention may be implemented. Computer system 400 includes a bus 402 or other communication mechanism for communicating information, and a hardware processor 404 coupled with bus 402 for processing information. Hardware processor 404 may be, for example, a general purpose microprocessor.

Computer system 400 also includes a main memory 406, such as a random access memory (RAM) or other dynamic storage device, coupled to bus 402 for storing information and instructions to be executed by processor 404. Main memory 406 also may be used for storing temporary variables or other intermediate information during execution of instructions to be executed by processor 404. Such instructions, when stored in non-transitory storage media accessible to processor 404, render computer system 400 into a special-purpose machine that is customized to perform the operations specified in the instructions.

Computer system 400 further includes a read only memory (ROM) 408 or other static storage device coupled to bus 402 for storing static information and instructions for processor 404. A storage device 410, such as a magnetic disk, optical disk, or solid-state drive is provided and coupled to bus 402 for storing information and instructions.

Computer system 400 may be coupled via bus 402 to a display 412, such as a cathode ray tube (CRT), for displaying information to a computer user. An input device 414, including alphanumeric and other keys, is coupled to bus 402 for communicating information and command selections to processor 404. Another type of user input device is cursor control 416, such as a mouse, a trackball, or cursor direction keys for communicating direction information and command selections to processor 404 and for controlling cursor movement on display 412. This input device typically has two degrees of freedom in two axes, a first axis (e.g., x) and a second axis (e.g., y), that allows the device to specify positions in a plane.

Computer system 400 may implement the techniques described herein using customized hard-wired logic, one or more ASICs or FPGAs, firmware and/or program logic which in combination with the computer system causes or programs computer system 400 to be a special-purpose machine. According to one embodiment, the techniques herein are performed by computer system 400 in response to processor 404 executing one or more sequences of one or more instructions contained in main memory 406. Such instructions may be read into main memory 406 from another storage medium, such as storage device 410. Execution of the sequences of instructions contained in main memory 406 causes processor 404 to perform the process steps described herein. In alternative embodiments, hard-wired circuitry may be used in place of or in combination with software instructions.

The term “storage media” as used herein refers to any non-transitory media that store data and/or instructions that cause a machine to operate in a specific fashion. Such storage media may comprise non-volatile media and/or volatile media. Non-volatile media includes, for example, optical disks, magnetic disks, or solid-state drives, such as storage device 410. Volatile media includes dynamic memory, such as main memory 406. Common forms of storage media include, for example, a floppy disk, a flexible disk, hard disk, solid-state drive, magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge.

Storage media is distinct from but may be used in conjunction with transmission media. Transmission media participates in transferring information between storage media. For example, transmission media includes coaxial cables, copper wire and fiber optics, including the wires that comprise bus 402. Transmission media can also take the form of acoustic or light waves, such as those generated during radio-wave and infra-red data communications.

Various forms of media may be involved in carrying one or more sequences of one or more instructions to processor 404 for execution. For example, the instructions may initially be carried on a magnetic disk or solid-state drive of a remote computer. The remote computer can load the instructions into its dynamic memory and send the instructions over a telephone line using a modem. A modem local to computer system 400 can receive the data on the telephone line and use an infra-red transmitter to convert the data to an infra-red signal. An infra-red detector can receive the data carried in the infra-red signal and appropriate circuitry can place the data on bus 402. Bus 402 carries the data to main memory 406, from which processor 404 retrieves and executes the instructions. The instructions received by main memory 406 may optionally be stored on storage device 410 either before or after execution by processor 404.

Computer system 400 also includes a communication interface 418 coupled to bus 402. Communication interface 418 provides a two-way data communication coupling to a network link 420 that is connected to a local network 422. For example, communication interface 418 may be an integrated services digital network (ISDN) card, cable modem, satellite modem, or a modem to provide a data communication connection to a corresponding type of telephone line. As another example, communication interface 418 may be a local area network (LAN) card to provide a data communication connection to a compatible LAN. Wireless links may also be implemented. In any such implementation, communication interface 418 sends and receives electrical, electromagnetic or optical signals that carry digital data streams representing various types of information.

Network link 420 typically provides data communication through one or more networks to other data devices. For example, network link 420 may provide a connection through local network 422 to a host computer 424 or to data equipment operated by an Internet Service Provider (ISP) 426. ISP 426 in turn provides data communication services through the world wide packet data communication network now commonly referred to as the “Internet” 428. Local network 422 and Internet 428 both use electrical, electromagnetic or optical signals that carry digital data streams. The signals through the various networks and the signals on network link 420 and through communication interface 418, which carry the digital data to and from computer system 400, are example forms of transmission media.

Computer system 400 can send messages and receive data, including program code, through the network(s), network link 420 and communication interface 418. In the Internet example, a server 430 might transmit a requested code for an application program through Internet 428, ISP 426, local network 422 and communication interface 418.

The received code may be executed by processor 404 as it is received, and/or stored in storage device 410, or other non-volatile storage for later execution.

In the foregoing specification, embodiments of the invention have been described with reference to numerous specific details that may vary from implementation to implementation. The specification and drawings are, accordingly, to be regarded in an illustrative rather than a restrictive sense. The sole and exclusive indicator of the scope of the invention, and what is intended by the applicants to be the scope of the invention, is the literal and equivalent scope of the set of claims that issue from this application, in the specific form in which such claims issue, including any subsequent correction.

What is claimed is:

1. A method comprising:
receiving, through an interface, campaign data that includes a first set of targeting criteria and a second set of targeting criteria;
in response to receiving the campaign data, establishing an online experiment that comprises a content delivery campaign that is associated with a treatment group and a control group;
after activating the online experiment, receiving a plurality of content requests;
for a first content request of the plurality of content requests:
identifying a first entity that initiated the first content request;
in response to determining that the first entity is targeted by the content delivery campaign based on the first set of targeting criteria, randomly assigning the first entity to the control group;
for a second content request of the plurality of content requests:
identifying a second entity that initiated the second content request;
in response to determining that the second entity is targeted by the content delivery campaign based on the first set of targeting criteria, randomly assigning the second entity to the treatment group;
wherein the method is performed by one or more computing devices.

2. The method of claim 1, further comprising:
in response to assigning the first entity to the control group, determining to not transmit any content item associated with the content delivery campaign to a computing device of the first entity.

3. The method of claim 1, further comprising:
in response to assigning the second entity to the treatment group, determining to transmit a content item associated with the content delivery campaign to a computing device of the second entity.

4. The method of claim 1, further comprising:
for a third content request of the plurality of content requests:
identifying a third entity that initiated the third content request;
in response to determining that the third entity is targeted by the content delivery campaign based on the second set of targeting criteria, randomly assigning the third entity to the control group;
in response to assigning the third entity to the control group, determining to transmit a content item associated with the content delivery campaign to a computing device of the third entity;
for a fourth content request of the plurality of content requests:
identifying a fourth entity that initiated the fourth content request;
in response to determining that the fourth entity is targeted by the content delivery campaign based on the second set of targeting criteria, randomly assigning the fourth entity to the treatment group;
in response to assigning the fourth entity to the treatment group, determining to not transmit any content item associated with the content delivery campaign to a computing device of the fourth entity.

5. The method of claim 1, further comprising:
determining a first entity identifier of the first entity;
performing one or more operations on the first entity identifier to generate a first value;
assigning the first entity to the control group in response to determining that the first value is within a first range;
determining a second entity identifier of the second entity;
performing the one or more operations on the second entity identifier to generate a second value that is different than the first value;
assigning the second entity to the treatment group in response to determining that the second value is within a second range that is different than the first range.

6. The method of claim 5, wherein performing the one or more operations comprises a hash operation and a modulo operation.

7. The Method of claim 1, wherein the campaign data indicates a percentage of a targeted audience to the control group or to the treatment group, wherein randomly assigning is based on the percentage.

8. The method of claim 1, wherein the campaign data includes a third set of targeting criteria that must be satisfied in order to identify the content delivery campaign as a candidate in a content item selection event, wherein attributes of the first entity and attributes of the second entity satisfy the third set of targeting criteria.

9. The method of claim 1, further comprising:
in response to receiving a particular content request of the plurality of content requests:
identifying a particular entity that initiated the particular content request;
identifying a plurality of online experiments that target the particular entity;
causing a count associated with each online experiment in the plurality of online experiments to increment;
as part of a content item selection event, selecting a strict subset of the plurality of online experiments for presentation;
causing content associated with at least online experiment in the strict subset to be presented to the particular entity;
for each online experiment in the plurality of online experiments, computing a performance measure based, at least in part, on the count associated with said each online experiment.

10. The method of claim 9, further comprising removing one or more online experiments outside the strict subset from consideration in the content item selection event based on one or more criteria.

11. The method of claim 10, wherein the one or more criteria includes (a) an effective amount per impression calculated for each online experiment in the plurality of online experiments or (b) a pacing measurement for each online experiment in the plurality of online experiments.

12. A method comprising:
receiving a content request;
in response to receiving the content request:
identifying a particular entity that initiated the content request;
identifying a plurality of candidate content deliver campaigns that includes a particular content delivery campaign that corresponds to an online experiment;
causing a count associated with the online experiment to increment;
as part of a content item selection event, selecting a strict subset of the plurality of candidate content delivery campaigns, wherein the strict subset does not include the particular candidate delivery campaign;
causing content associated with the strict subset to be transmitted, over a computer network, to a computing device of the particular entity;
computing a performance measure for the online experiment;
based, at least in part, on the count associated with the online experiment, determining whether the performance measure is statistically significant;
wherein the method is performed by one or more computing devices.

13. The method of claim 12, wherein causing the count to increment comprises:
generating an event that identifies the online experiment and a variant to which the particular entity is assigned;
causing the event to be stored in memory;
reading the event from the memory and processing the event, wherein processing the event comprises incrementing the count based on the event.

14. One or more storage media storing instructions which, when executed by one or more processors, cause:
receiving, through an interface, campaign data that includes a first set of targeting criteria and a second set of targeting criteria;
in response to receiving the campaign data, establishing an online experiment that comprises a content delivery campaign that is associated with a treatment group and a control group;
after activating the online experiment, receiving a plurality of content requests;
for a first content request of the plurality of content requests:
identifying a first entity that initiated the first content request;
in response to determining that the first entity is targeted by the content delivery campaign based on the first set of targeting criteria, randomly assigning the first entity to the control group;
for a second content request of the plurality of content requests:
identifying a second entity that initiated the second content request;
in response to determining that the second entity is targeted by the content delivery campaign based on the first set of targeting criteria, randomly assigning the second entity to the treatment group.

15. The one or more storage media of claim 14, wherein the instructions, when executed by the one or more processors, further cause:
in response to assigning the first entity to the control group, determining to not transmit any content item associated with the content delivery campaign to a computing device of the first entity;
in response to assigning the second entity to the treatment group, determining to transmit a content item associated with the content delivery campaign to a computing device of the second entity.

16. The one or more storage media of claim 14, wherein the instructions, when executed by the one or more processors, further cause:
for a third content request of the plurality of content requests:
identifying a third entity that initiated the third content request;
in response to determining that the third entity is targeted by the content delivery campaign based on the second set of targeting criteria, randomly assigning the third entity to the control group;
in response to assigning the third entity to the control group, determining to transmit a content item associated with the content delivery campaign to a computing device of the third entity;
for a fourth content request of the plurality of content requests:
identifying a fourth entity that initiated the fourth content request;
in response to determining that the fourth entity is targeted by the content delivery campaign based on the second set of targeting criteria, randomly assigning the fourth entity to the treatment group;
in response to assigning the fourth entity to the treatment group, determining to not transmit any content item associated with the content delivery campaign to a computing device of the fourth entity.

17. The one or more storage media of claim 14, wherein the instructions, when executed by the one or more processors, further cause:
determining a first entity identifier of the first entity;
performing one or more operations on the first entity identifier to generate a first value;
assigning the first entity to the control group in response to determining that the first value is within a first range;
determining a second entity identifier of the second entity;
performing the one or more operations on the second entity identifier to generate a second value that is different than the first value;
assigning the second entity to the treatment group in response to determining that the second value is within a second range that is different than the first range.

18. The one or more storage media of claim 14, wherein the campaign data indicates a percentage of a targeted audience to the control group or to the treatment group, wherein randomly assigning is based on the percentage.

19. The one or more storage media of claim 14, wherein the campaign data includes a third set of targeting criteria that must be satisfied in order to identify the content delivery campaign as a candidate in a content item selection event, wherein attributes of the first entity and attributes of the second entity satisfy the third set of targeting criteria.

20. The one or more storage media of claim 14, wherein the instructions, when executed by the one or more processors, further cause:
in response to receiving a particular content request of the plurality of content requests:
identifying a particular entity that initiated the particular content request;
identifying a plurality of online experiments that target the particular entity;
causing a count associated with each online experiment in the plurality of online experiments to increment;
as part of a content item selection event, selecting a strict subset of the plurality of online experiments for presentation;
causing content associated with at least online experiment in the strict subset to be presented to the particular entity;
for each online experiment in the plurality of online experiments, computing a performance measure based, at least in part, on the count associated with said each online experiment.
